(19) United States
(12) Patent Application Publication
(10) Pub. No.: US 2003/0117790 A1
(43) Pub. Date: Jun. 26, 2003

(54) Backlight unit of liquid crystal display

(75) Inventors: Ching-Ping Lee, Miao Li Hsien (TW); Nai-Yuan Tang, Taipei (TW)

Correspondence Address: BRUCE H. TROXELL, SUITE 1404, 5205 LEESBURK PIKE, FALLS CHURCH, VA, 22041, US

(73) Assignee: Au Optronics Corp.

(21) Appl. No.: 10/318,134

(22) Filed: Dec. 13, 2002

(30) Foreign Application Priority Data
Dec. 21, 2001 (TW) 90131836

(51) Int. Cl. F21V 8/00

(52) U.S. Cl. 362/31; 362/30; 362/330; 362/336

(57) ABSTRACT

A backlight unit for enhancing brightness of a TFT-LCD device is disclosed. The backlight unit comprises a lamp and a light guide plate. The light guide plate has a top surface and one side. And the lamp is fastened to the side of the light guide plate for illumination. The light is multiple reflected in the light guide plate and emitted from the top surface of the light guide plate. The backlight unit further comprises an optical film and an adhesive layer, wherein the optical film is disposed on the light guide plate to spread the light uniformly, and the adhesive layer is applied to fill gaps between the light guide plate and the optical film. The adhesive layer has a refractive index equal to that of the light guide plate and the optical film for decreasing multiple reflections therebetween.

### FIELD OF THE INVENTION

The present invention relates to the backlight unit of a thin film transistor liquid crystal display and, more specifically, to a backlight unit applied to promote brightness of TFT-LCD devices.

### BACKGROUND OF THE INVENTION

With the advance of techniques for manufacturing thin-film transistors, the liquid crystal displays (LCD) are widely applied in electrical products, such as PDAs, laptops, cellphones, high resolution television sets, etc. due to advantages as smaller size, portability, and lower power consumption. Especially when vast amounts of money have been expended to research and develop improved materials, processes and equipments for producing LCD devices, the qualities of the LCDs are promoted and costs thereof are reduced substantially. It is required to introduce backlight units into the LCDs for illumination because the liquid crystal molecules are non-illumination materials. Therefore the backlight unit is the most importance element for manufacturing the LCD devices, and the performance thereof is closely related to the displaying effect of the LCD.

Refer to FIG. 1, the backlight unit 10 applied to the conventional LCDs comprises a light guide plate 10, an optical film 12, a reflective plate 14, a lamp 16 and a reflective cover 18. The light guide plate 10 is generally formed by acrylic materials. And plural dots 11 with circle, hexagon, or square patterns are defined beneath the light guide plate 10 by performing screen processes or injection processes. According to different applications, the light guide plates can be made to present a square appearance in display means of PC; or to present a wedge appearance applied in notebooks to save space. The lamp 16 made of a cold cathode tube is fastened to one side of the light guide plate 10 for providing the edgelight. The light illuminated into the light guide plate 10 is then multiple reflected and transmitted to the another side of the light guide plate 10. When the light is irradiated onto the diffuser dots 11, the reflected light can be diffused uniformly and emitted out of light guide plate 10 upwardly.

The reflector cover 18 disposed the outside of the lamp 16 with a “C” type appearance has an openning 19. The light of the lamp 16 is gathered by the reflector cover 1 8 and transmitted through the opening 19 into the light guide plate 10. Besides the reflector plate 14 is mounted beneath the light guide plate 10 to reflect the light emitted from the lower surface thereof. And the optical film 12 constituted of several thin films is disposed on the light guide 10. As shown in the FIG. 1, the optical film 12 includes an upper diffuser film 12a, a brightness enhanced film 12b, and a lower diffuser film 12c. The lower diffuser film 12c is heavy misted to spread the light uniformly and to make the sharpness more smooth. In general, the brightness enhanced film 12b is made of prizm or polarizer to aggregate light. As to the lightly misted upper diffuser film 12a is applied to spread light uniformly and protect the films beneath from scrapes in later package procedures.

It is noted that for the purpose of preventing the interference such as Newton ring from occurring, some outstanding micro-protrusions 17 are made beneath the lower diffuser film 12c to make the lower surface rough. However these outstanding micro-protrusions 17 also cause gaps 13 with pitches of about several decade micrometers between the lower diffuser film 12c and the light guide plate 10. And the refractive index of the lower diffuser film 12c and the light guide plate 10 both are about 1.5, so the air fill in the gaps 13 with refractive index about 1 will make the light reflect multiple between the lower diffuser film 12c and the light guide plate 10 as shown in FIG. 1. Thus the energy loss of reflective light will reduce the brightness of the backlight unit. Therefore if the multiple reflections between the lower diffuser film 12c and the light guide plate 10 can be reduced or eliminated, the energy loss can be reduced and brightness of the backlight unit can be promoted considerably.

### SUMMARY OF THE INVENTION

The first objective of the present invention is to provide a backlight unit for enhancing brightness of TFT-LCD devices.

Another objective of the present invention is to provide a backlight unit which can reduce the multiple reflections between the light guide plate and the optical films.

The further objective of the present invention is to provide a backlight unit wherein an adhesive layer is applied to substitute for the diffuser.

The present invention discloses a backlight unit for enhancing brightness of a TFT-LCD device. The backlight unit comprises a lamp and a light guide plate. The light guide plate has a top surface and one side. And the lamp is fastened to the side of the light guide plate for illumination. The light radiated from the lamp is transmitted into the light guide plate and then multiple reflected therein and finally emitted from the top surface of the light guide plate. The backlight unit further comprises an optical film and an adhesive layer, wherein the optical film is disposed on the light guide plate to spread the light uniformly, and the adhesive layer is applied to fill gaps between the light guide plate and the optical film. The adhesive layer has a refractive index about 1.4˜1.6 which is equal to that of the light guide plate and the optical film for preventing from multiple reflections therebetween.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross sectional view of the backlight unit of the TFT-LCD device in accordance with the prior art;

FIG. 2 is a cross sectional view of the backlight unit of the TFT-LCD device in accordance with the first embodiment of the present invention;

FIG. 3 is a cross sectional view of the backlight unit of the TFT-LCD device in accordance with the second embodiment of the present invention;

FIG. 4 is a cross sectional view of the backlight unit of the TFT-LCD device in accordance with the third embodiment of the present invention; and

FIG. 5 is a cross sectional view of the backlight unit of the TFT-LCD device in accordance with the fourth embodiment of the present invention.

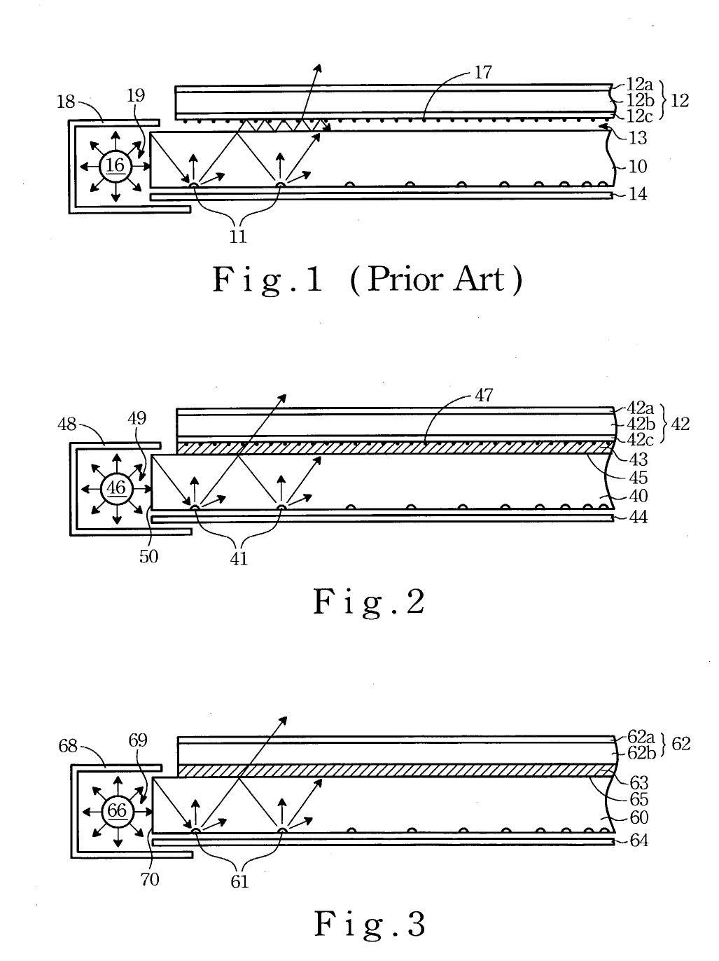

### DETAILED DESCRIPTION OF THE PREFERRED EMBODIMENT

A backlight unit is disclosed hereinafter to enhance the brightness of the TFT-LCD devices. An adhesive layer is disposed between a light guide plate and an optical film to fill gaps therebetween. Notedly the adhesive is applied to prevent the light between the light guide plate and the optical film from multiple reflections which cause the energy loss. Besides, the adhesive layer can be doped with micro-particles to serve as a diffuser. The detailed description is given as following.

### The First Embodiment

Refer to FIG. 2, a backlight unit disclosed in the present invention for enhancing brightness of a TFT-LCD device is illustrated. The elements of backlight unit comprise a light guide plate 40, an optical film 42, a reflector plate 44, a lamp 46 and a reflector cover 48. The light guide plate 40 has a top surface 45 and one side 50. The lamp 46 is fastened to the side 50 of the light guide plate 40 for illumination. The light guide plate 40 has smooth surfaces. And according to different applications, the light guide plates are designed to present a square appearance used for liquid crystal displays; or to present a wedge appearance used for notebooks to save space. The light radiated from the lamp 46 is transmitted into the light guide plate 40 and then multiple reflected therein and finally emitted from the top surface 45 of the light guide plate 40. The light guide plate 40 is generally formed by acrylic materials. And plural dots 41 with circle, hexagon, or square patterns are defined on a lower surface of the light guide plate 40 by performing screen processes or injection processes. These dots 41 are formed generally of high-reflective and light-unabsorbable materials, such as titania or barium sulfate, to serve as diffuser dots 41 for spreading light uniformly.

The lamp 46 fastened to the side 50 can transmit the light into the light guide plate 40 with the edgelight mode. The light then is multiple reflected in the light guide plate 40 and transmitted to the far another side of the light guide plate 40. When the light is irradiated to the diffuser dots 41, the reflected light can be diffused uniformly and emitted out of the light guide plate 40 from top surfaces thereof. In general, the lamp 46 can be chosen from the cold cathode tube with a diameter of several millimeters. And the reflector cover 48 dispose on the outside of the lamp 46 with a “C” type appearance has an opening 49. Namely the reflector cover is disposed to encompass the lamp 46, and the opening 49 is towards to the side of light guide plate 40 for providing illumination. The illumination of the lamp 46 is reflected and gathered by the reflector cover 48 and transmitted through the opening 49 into the light guide plate 40 to promote the illumination efficiency of the light from the side 50 into the light guide plate 40. Besides the reflector plate 44 is mounted beneath the light guide plate 40 to reflect the light emitted from the lower surface of the light guide plate 40.

The optical film 42 is constituted of several thin films and is disposed onto the top surface of the light guide plate 40 to make the light emitted therefrom more uniformly. As shown in FIG. 2, in the preferred embodiment, the optical film 42 includes an upper diffuser film 42a, a brightness enhanced film 42b, and a lower diffuser film 42c. The lower diffuser film 42c is heavy misted to spread the light uniformly and to make the brightness and sharpness more smooth. In general, the brightness enhanced film 42b is made of prizm or polarizer like dual brightness enhanced film (DBEF) to aggregate light. Relatively the upper diffuser film 42a lightly misted is applied to protect the films beneath from scrapes in later package procedures for the most part. Also the upper diffuser film 42a is applied to spread light uniformly.

For the purpose of preventing the interference such as Newton ring, some micro-protrusions 47 are made beneath the lower diffuser film 42c to make the lower surface rough. However these micro-protrusions 47 also render gaps of several decade micrometers occur between the lower diffuser film 42c and the light guide plate 40. For solving the gap issues, an adhesive layer 43 is introduced between the lower diffuser film 42c and the light guide plate 40 to fill all the gaps. The adhesive layer has a refractive index about 1.4˜1.6 which is equal to that of the light guide plate 40 and the lower diffuser film 42c for decreasing multiple reflections therebetween. Thus the light emitted from the light guide plate 40 can penetrate upwardly through the adhesive layer 43 and the lower diffuser film 42c directly to prevent multiple reflections.

### The Second Embodiment

Except the application of introducing the adhesive layer to fill the gaps as described above, the adhesive layer can also be doped with some micro-particles to have the effect of diffusing light. Refer to FIG. 3, the backlight unit comprises a light guide plate 60, an optical film 62, a reflector plate 64, a lamp 66 and a reflector cover 68. The light guide plate 60 has a top surface 65 and one side 70, and beneath the lighguide plate 60 some diffuser dots 61 are formed. The lamp 66 fastened to the side 70 of the light guide plate 60 can provide the edgelight for illumination. The light then is multiple reflected in the light guide plate 60 and finally emitted uniformly out the upper surfaces thereof. The reflector cover 68 disposed the outside of the lamp 66 has a “C” type appearance with an opening 69. The light of the lamp 66 is gathered by the reflector cover 68 and transmitted through the opening 69 into the light guide plate 60. Besides the reflector plate 64 is mounted beneath the light guide plate 60 to reflect the light emitted from the lower surface thereof.

It is noted that the optical film 62 only includes a diffuser film 62a and a brightness enhanced film 62b. An adhesive layer 63 is introduced between the brightness enhanced film 62b and the light guide plate 60 to fill all the gaps therebetween. In the preferred embodiment the semi-transparent adhesive layer 63 with micro-particles doped therein is used to have the effect of diffusing light. The adhesive layer 63 is applied to prevent the light from multiple reflections. Namely the adhesive layer 63 can be used to substitute for the lower diffuser film to diffuse uniformly the light emitted from the light guide plate 60. Besides the capability of diffusing light for the adhesive layer 63 can be controlled by adjusting the density and patterns of the micro-particles therein.

### The Third Embodiment

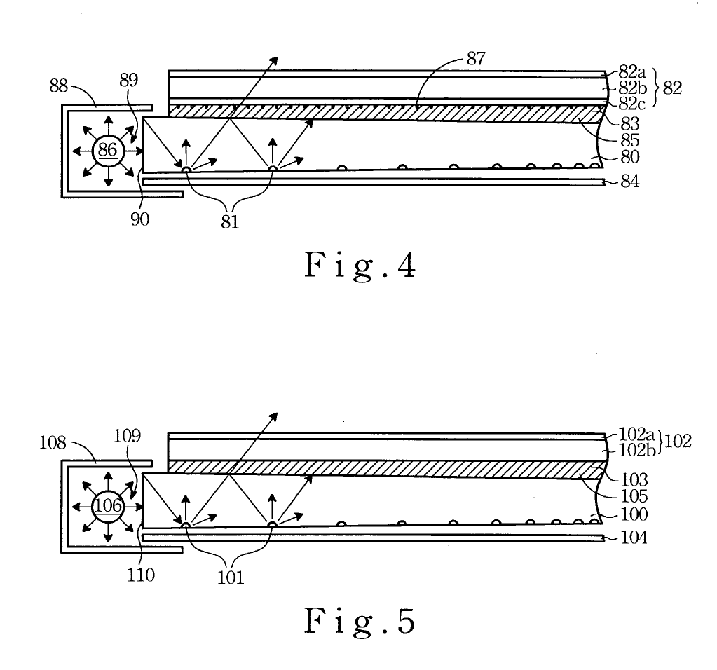

Please refer to FIG. 4, a backlight unit applied to notebooks for enhancing brightness of a TFT-LCD device is illustrated. The elements of backlight unit comprise a light guide plate 80, an optical film 82, a reflector plate 84, a lamp 86 and a reflector cover 88. The light guide plate 80 has a wedge appearance to save place, and has a top surface 85 and one side 90. The light introduced into the light guide 80 is multiple reflected therein and finally emitted out of the top surface 85. And the lower surfaces of the light guide plate 80 has plural dots 81 defined beneath.

The lamp 86 is fastened to the side 90 of the light guide plate 80 for edge-lighting to transmit light into the light guide plate 80. The light then is multiple reflected in the light guide plate 80 and transmitted to another far side of the wedge light guide plate 80. When the light is irradiated to the diffuser dots 41, the reflected light is diffused uniformly and emitted out of the light guide plate 80 from top surfaces 85 thereof. Samely the reflector cover 88 disposed the outside of the lamp 86 with a “C” type appearance has an opening 89. The light of the lamp 86 is gathered by the reflector cover 88 and transmitted through the opening 89 into the light guide plate 80. Besides the reflector plate 84 is mounted beneath the light guide plate 80 to reflect the light emitted from the lower surface of the light guide plate 80.

The optical film 82 is made of several thin films and disposed onto the top surface of the light guide 80. As shown in the FIG. 4, the optical film 82 includes an upper diffuser film 82a, a brightness enhanced film 82b, and a lower diffuser film 82c. The lower diffuser film 82c is heavy misted to spread the light uniformly and to make the brightness and sharpness more smooth. In general, the brightness enhanced film 82b is made of prizm or polarizer like dual brightness enhanced film(DBEF). Relatively the upper diffuser film 82a is lightly misted to spread light uniformly and protect the films beneath from scrapes in later package procedures.

Some micro-protrusions 87 are made beneath the lower diffuser film 82c to make the lower surface rough. However these micro-protrusions 87 also render gaps of several decade micrometers occur between the lower diffuser film 82c and the light guide plate 80. For solving the gap issues, an adhesive layer 83 is introduced between the lower diffuser film 82c and the light guide plate 80 to fill all the gaps. The adhesive layer 83 has a refractive index about 1.4˜1.6 which is equal to that of the light guide plate 80 and the lower diffuser film 82c for decreasing multiple reflections therebetween. Thus the light emitted from the light guide plate 80 can penetrate through the adhesive layer 83 and the lower diffuser film 82c upwards and directly to prevent multiple reflections.

### The Fourth Embodiment

Then refer to FIG. 5, this Figure illustrates the adhesive layer doped with some micro-particles is applied to fill the gaps and to diffuse light. The backlight unit comprises a light guide plate 100, an optical film 102, a reflector plate 104, a lamp 106 and a reflector cover 108. The light guide plate 100 with a wedge appearance has diffuser dots 111 formed beneath, and has a top surface 105 and one side 110. The lamp 106 fastened to the side 110 of the light guide plate 100 to provide the edgelight. The light then is multiple reflected in the light guide plate 100 and finally emitted out from the top surfaces thereof. The reflector cover 108 disposed on the outside of the lamp 106 has a “C” type appearance with an opening 109. The light of the lamp 106 is gathered by the reflector cover 108 and transmitted from the opening 109 into the light guide plate 100 to promote the efficiency of light into the light guide plate 100. Besides the reflector plate 104 is mounted beneath the light guide plate 100 to reflect the light emitted from the lower surface thereof to increase the illumination efficiency.

The optical film 102 only include a diffuser film 102a and a brightness enhanced film 102b. An adhesive layer 103 is introduced between the brightness enhanced film 102b and the light guide plate 100 to fill all the gaps therebetween. In the preferred embodiment the semi-transparent adhesive layer 103 with micro-particles doped therein is used to diffuse light emitted from the light guide plate 100. The adhesive layer 103 is applied to substitute the lower diffuser film for preventing the light from multiple reflections and for diffusing uniformly the light emitted from the light guide plate 100. Samely the capability of diffusing light of the adhesive layer 103 can be controlled by adjusting the density and patterns of the micro-particles therein.

The backlight unit disclosed in the present invention has many advantages as follows:

(1) By applying the adhesive layer to fill the gaps between the light guide plate and the optical film for preventing the light from multiple reflections therebetween to increase brightness of the backlight unit.

(2) The semi-transparent adhesive layer with micro-particles doped therein can be introduced to substitute for the lower diffuser film to provide effects of light diffusing.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. For example, for another type of TFT-LCDs, the lamp is disposed beneath the light guide plate to provide illumination with a backlight mode. However the adhesive layer can also be applied to this type of TFT-LCD devices.

While the preferred embodiment of the invention has been illustrated and described, it will be appreciated that various changes can be made therein without departing from the spirit and scope of the invention.

What is claimed is:

1. A backlight unit for enhancing brightness of a TFT-LCD device comprises of:
a lamp for providing a light;
a light guide plate having a top surface and one side, wherein said light is multiple reflected in said light guide plate and emitted from said top surface of said light guide plate, said lamp is fastened to said side of said light guide plate to illuminate said light into said light guide plate with an edgelight form;
an optical film disposed on said light guide plate to spread uniformly said light emitted from said light guide plate; and
an adhesive layer disposed between said light guide plate and said optical film to fill gaps between said light guide plate and said optical film to prevent said light from multiple reflections between said light guide plate and said optical film.

2. The backlight unit of claim 1, wherein a refractive index of said adhesive layer is equal to that of said light guide plate and said optical film.

3. The backlight unit of claim 1, wherein said optical film comprises an upper diffuser, a brightness enhanced film and a lower diffuser.

4. The backlight unit of claim 3, wherein said brightness enhanced film can be chosen from a prizm, a polarizer, or any combination thereof.

5. The backlight unit of claim 1, wherein said optical film comprises a diffuser.

6. The backlight unit of claim 5, wherein refractive index of said diffuser and said light guide plate are both about 1.4˜1.6, and a refractive index of said adhesive layer is about 1.4˜1.6 to prevent said light from multiple reflections between said light guide plate and said diffuser.

7. The backlight unit of claim 1, wherein said optical film comprises a brightness enhanced film.

8. The backlight unit of claim 7, wherein said brightness enhanced film can be chosen from a prizm, a polarizer or any combination thereof.

9. The backlight unit of claim 7, wherein refractive index of said diffuser and said light guide plate are both about 1.4˜1.6, and a refractive index of said adhesive layer is about 1.4˜1.6 to prevent said light from multiple reflections between said light guide plate and said diffuser.

10. The backlight unit of claim 1, wherein said adhesive layer has micro-particles doped therein to diffuse said light.

11. The backlight unit of claim 1, wherein a reflector cover encompassing said lamp has an opening towards said light guide plate, and illuminations of said lamp are reflected and gathered by said reflector cover and transmitted into said light guide plate through said open.

12. The backlight unit of claim 1, further comprising a reflector plate mounted beneath said light guide plate to reflect lights emitted from a lower surface of said light guide plate.

13. A backlight unit for enhancing brightness of a TFT-LCD device comprises of:
a lamp for providing a light;
a light guide plate having a top surface, wherein said light is multiple reflected in said light guide plate and emitted from said top surface thereof, said lamp is disposed beneath said light guide plate to illuminate said light into said light guide plate with an backlight form;
an optical film disposed on said light guide plate to spread said light emitted from said light guide plate uniformly; and
an adhesive layer disposed between said light guide plate and said optical film to fill gaps therebetween to reduce multiple reflections of said light between said light guide plate and said optical film.

14. The backlight unit of claim 13, wherein a refractive index of said adhesive layer is equal to that of said light guide plate and said optical film to prevent said light from multiple reflections between said light guide plate and said optical film.

15. The backlight unit of claim 13, wherein said optical film comprises a diffuser.

16. The backlight unit of claim 15, wherein refractive index of said diffuser and said light guide plate are both about 1.4˜1.6, and a refractive index of said adhesive layer is about 1.4˜1.6 to prevent said light from multiple reflections between said light guide plate and said diffuser.

17. The backlight unit of claim 13, wherein said optical film comprises a brightness enhanced film.

18. The backlight unit of claim 17, wherein refractive index of said diffuser and said light guide plate are both about 1.4˜1.6, and a refractive index of said adhesive layer is about 1.4˜1.6 to prevent said light from multiple reflections between said light guide plate and said diffuser.

19. The backlight unit of claim 13, wherein said adhesive layer has micro-particles doped therein to diffuse said light.

20. The backlight unit of claim 13, further comprising a reflector plate mounted beneath said light guide plate to reflect lights emitted from a lower surface of said light guide plate.
